(19) United States
(12) Patent Application Publication
(10) Pub. No.: US 2011/0058035 A1
(43) Pub. Date: Mar. 10, 2011

(54) SYSTEM AND METHOD FOR RECORDING SECURITY SYSTEM EVENTS

(75) Inventors: Ronald David DeBerry, Corinth, TX (US); Mitchell Wayne Crowsey, Pilot Point, TX (US)

(73) Assignee: Keri Systems, Inc. A. California Corporation, San Jose, CA (US)

(21) Appl. No.: 12/875,050

(22) Filed: Sep. 2, 2010

Related U.S. Application Data
(60) Provisional application No. 61/239,411, filed on Sep. 2, 2009.

(51) Int. Cl. H04N 7/18

(52) U.S. Cl. 348/143; 348/E07.085

(57) ABSTRACT

An event-based recording access control and security management system includes an access control system having one or more access control devices, a recording system having one or more recording devices, a first gateway configured to generate a message identifying time of occurrence of a hardware event representative of operation of an access control device, and an event video recorder (EVR) configured to command information capture by a recording device of the recording system based on the hardware event, and to associate the captured information with the message by including in the message a timestamp of the hardware event and of the information capture.

### CROSS-REFERENCE TO RELATED APPLICATIONS

The present application claims the benefit of priority based on U.S. Provisional Patent Application Ser. No. 61/239,411, filed on Sep. 2, 2009, in the name of inventors Ronald David DeBerry, and Mitchell Wayne Crowsey, entitled “SYSTEM AND METHOD FOR RECORDING SECURITY SYSTEM EVENTS AND ASSOCIATED VIDEO IMAGES”, which is hereby incorporated herein by reference in its entirety.

### TECHNICAL FIELD

The present disclosure relates generally to security systems employing sensors to detect events which systems also include a video camera system for recording images of associated events.

### BACKGROUND

The physical security industry is engaged in providing, among other things, access control to environments such as buildings, public and private facilities, and the like, and video surveillance of such buildings, facilities and the like. There is a challenge within the physical security industry when it comes to associating security video with access control. There are literally hundreds of manufacturers of security video components which are used in the security environment. Similarly there are many manufacturers of access control equipment and components used in the security environment. There is a need to accurately match operation of such access control equipment with security video so that the security video may be valid in an evidence context as well as for other uses to which it may be directed—for example: identification, crowd management, safety management, and the like.

As used herein, access control refers to permitting or denying access through a controlled portal (such as a building door, gate, garage door, window, or the like) to a restricted area, or the like by means of sensors, input devices, RFID (Radio Frequency Identification) card readers/interrogators, biometric sensors, and the like. Security video includes video systems which include cameras, lenses, format converters, transmission systems and storage systems to capture video images such as still frames, bursts of still frames, full motion video and the like. Most present day video systems render an output in a digital format such as, for example, MPEG-2 or MPEG-4 (standards defining video streams developed by the Motion Picture Experts Group), or one of a number of other known formats. Most of these outputs include either an embedded time code embedded digitally within the video stream itself and/or an optical time code visible in the video image and representative of the time and/or date at which the video was captured.

What is proving difficult at the present time is to reliably associate a particular event (such as a sensor detecting a door opening) with video from a camera pointed at the door so that, for example, one can easily demonstrate that a given person identified in the video from the camera was the one to enter through the opened door. In many cases built-in electronic clocks associated with video systems and/or computers with their own built-in electronic clocks logging physical events drift, or are not synchronized or set properly, so that the evidentiary value of the video is potentially compromised and, e.g., the given person identified in the video cannot be said reliably to have been the one causing the door to open at a given time due to the conflicting time records.

Turning now to FIG. 1, a typical access control system 100 includes an access control system controller 102 with a system clock 104. The access controller 102 may be implemented in part with a general purpose computer as illustrated in block diagram form in FIG. 2 and including standard elements 106-138 as called out in FIG. 2. These include a communications bus 106; a central processor 108; a system memory 112; a display such as display screen 114 with a display adapter 116; a first serial port 118 through which a pointer device such as mouse 134 is coupled; a keyboard 122; a second serial port 120 through which a modem 136 is coupled; a storage device (for example CD/DVD) reader 130 for receiving a readable and/or writable medium such as a CD/DVD 132; a network interface adapter 138; a fixed memory device 124; and a USB interface 126 through which removable storage device 128 is coupled.

Returning to FIG. 1, the access control system 100 includes RFID readers 140, 142 and 144 which read RFID cards presented by users attempting to access the facility. Locks 146, 148 and 150 may be activated by the access control system 100 so that doors or other locked system elements may be opened or otherwise accessed. Switches 152, 154 and 156 provide other user inputs to the system (e.g., like a door bell or some other form of input such as a keypad for typing in a predetermined or rolling code). Outputs 158, 160, 162 may be signaling outputs that are audibly or visually perceivable by a user to indicate a status of the system (e.g., the door is now unlocked). An event log database 164 is maintained, e.g., on fixed disk 124, which records events and their associated times/dates as determined by the system clock 104.

Turning to FIG. 3, there is shown a recording system 166. Recording system 166 is described in terms of video, but it will be understood that other types of events—such as sound—may be captured by the system 166, in addition to video or as an alternative. Recording system 166 includes analog cameras 168, 170 and digital IP camera 172 which provide video signals to recording system 166. The video is digitized either at the camera, at an intermediate converter, or elsewhere in the system 166. A system clock 176 associated with the video system 166 provides time code functionality to the video signals. The video signals are recorded on a digital video recorder (DVR)/network video recorder (NVR) 178. Rules may be applied to record all video, or only certain video, e.g., video occurring around the time of an event as determined by a sensor of the access control system, or periodically, or based on motion detection in the video, and the like.

Because the access control and video systems are more or less independent, there is no easy way to insure synchronization of events with associated video. What is needed is an improved method and apparatus for storage and retrieval of event information and associated video.

### SUMMARY

As described herein, an event-based recording access control and security management system includes an access control system having one or more access control devices, a recording system having one or more recording devices, a first gateway configured to generate a message identifying time of occurrence of a hardware event representative of operation of an access control device, and an event video recorder (EVR) configured to command information capture by a recording device of the recording system based on the hardware event, and to associate the captured information with the message by including in the message a timestamp of the hardware event and of the information capture.

Also as described herein, method for associating an access control device with recorded information includes timestamping a hardware event representative of operation of a first access control device, generating a message identifying the first access control device and the timestamp, and commanding a recording device to capture information based on the hardware event, and to associate the captured information with the message by including in the message the timestamp of the hardware event and a timestamp of the information capture.

Also as described herein, a device for associating an access control device with recorded information includes means for timestamping a hardware event representative of operation of a first access control device, means for generating a message identifying the first access control device and the timestamp, and means for commanding a recording device to capture information based on the hardware event, and to associate the captured information with the message by including in the message the timestamp of the hardware event and a timestamp of the information capture.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a system block diagram of an access control system in accordance with the prior art.

FIG. 2 is a system block diagram of an access control system controller in accordance with the prior art.

FIG. 3 is a system block diagram of a video system in accordance with the prior art.

FIG. 4 is a system block diagram illustrating an embodiment of the present invention.

FIG. 5 is a diagram illustrating a camera imaging a door.

FIG. 6 is a process flow diagram in accordance with an embodiment of the present invention.

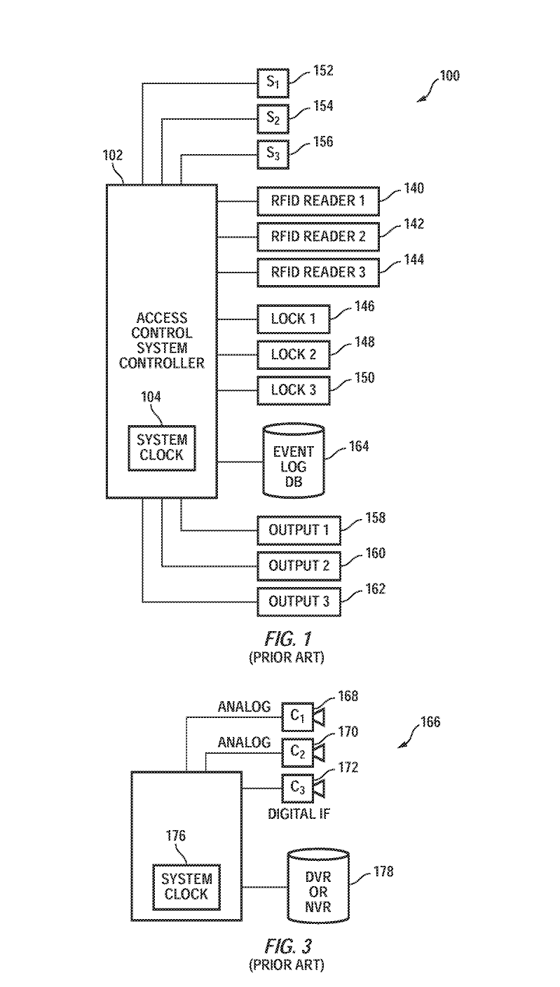

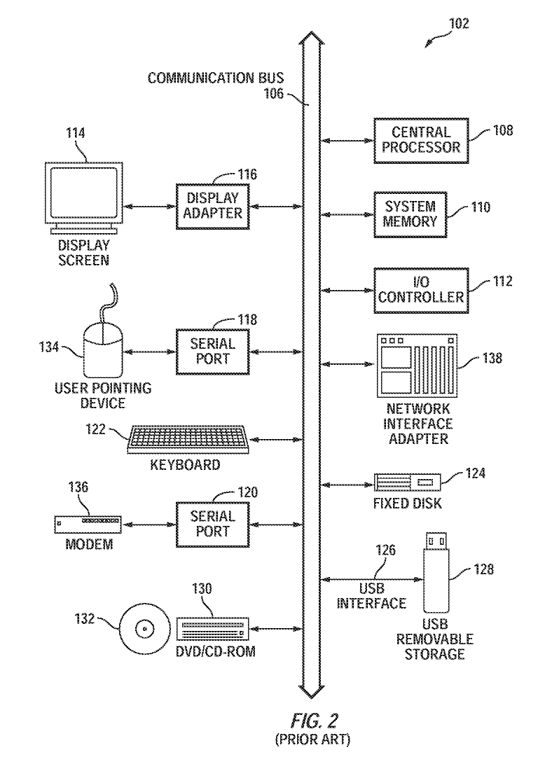

### DESCRIPTION OF EXAMPLE EMBODIMENTS

Example embodiments are described herein in the context of a security systems for a building. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

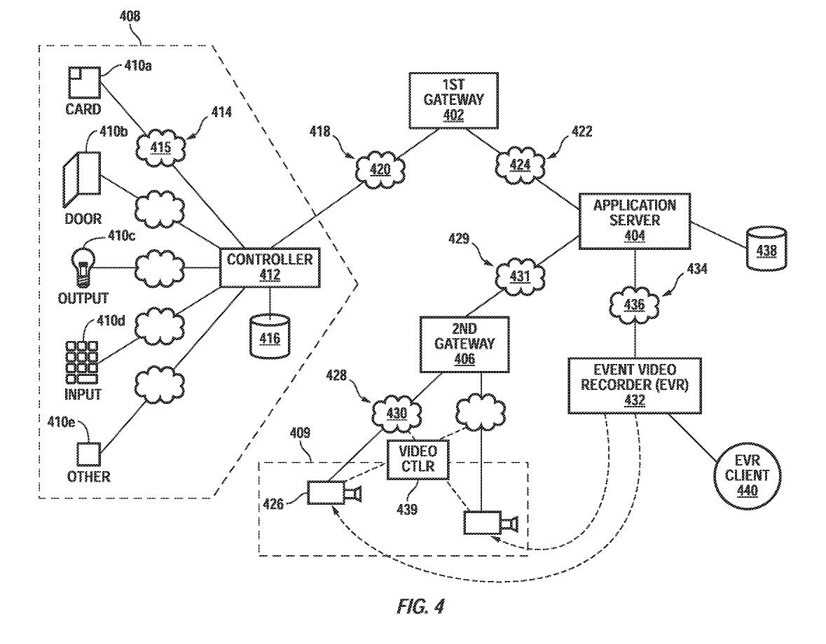

In accordance with an embodiment, an event-based recording access control and security management system is provided. Such a system 400 is described with reference to FIG. 4 and includes a first gateway 402 for processing hardware events into messages forwarded to an application server 404, and a second gateway 406 for processing camera/recorder events into messages forwarded to the application server for further processing. It will be appreciated that both gateways 402 and 406 can be combined into one device if desired. Hardware events are associated with a control system shown generally at 408 and relate to access control of portals such as gates, doors, windows, garage doors and the like using sensors, input devices, RFID (Radio Frequency Identification) card readers/interrogators, biometric sensors, and the like. One or more control systems may be provided (only one is shown). Camera/recorder events are associated with a recording system 409 including for example video or still cameras 426 or other recording devices. One or more recording systems 409 may be provided (only one is shown). The camera/recorder events relate generally to capture, processing and storage of audio and/or video images such as still frames, bursts of still frames, full motion video and the like.

A physical implementation utilizing the system 400 is shown schematically in FIG. 5, wherein the control system is manifested at least in part as an RFID reader 502 controlling access to a door 506, and wherein the camera/recording system is manifested at least in part as an overhead security camera 508 trained at the door in order to selectively capture images of activities at the door as determined by the system 400. The camera 508 may be a digital video recorder (DVR), network video recorder (NVR), or IP (internet protocol) camera.

Returning to FIG. 4, it can be seen that the control system 408 includes what are termed access control devices, collectively referred to as access control devices 410n and individually generally referred to as access control device 410N. The access control devices 410n are in communication with a controller 412 by way of a communication link 414. The communication link 414 may be wired or wireless and may be over any known network or networks 415, including the Internet. The access control devices 410n can include for instance an information-bearing card 410a (for example an RDID card), a portal (for example door) 410b, an output device (for example bulb or LED or horn) 410c, an input device (button, keypad, lever, photosensor, capacitive proximity sensor, etc.) 410d, and any other device 410e.

The access control devices 410n are each assigned a unique identifier (UID), stored for example in a database 416 of control system 408. In the case of a card 410a associated with an individual, the card and/or individual is assigned the UID. Also assigned to each access control device 410N is a set of rules that detail how to treat events that occur at, or by, that entity. The rules, which may be referred to herein as “filters,” may also be stored in database 416. Each access control device may also be assigned or associated with one or more cameras or recorders, with such assignment stored in database 416.

The access control devices 410n are configured to trigger notifications when they detect a hardware event. A hardware event can be for example a swipe of an RFID tag across a reader, detection of the presence of a person at a proximity detector, opening of a door or window, breaking of a light beam, and the like. Details of the notifications may be stored in local database 416. These details can include information such as that identifying the particular access control device 410N responsible for the hardware event, the time (GMT and/or local) of the occurrence of the event and the time that the notification was stored in the local database 417.

The notifications are sent to the gateway 402 over a communication link 418 with the control system 408. The communication link 418 may be wired or wireless and may be over any known network or networks 420, including the Internet. The gateway 402 then creates a virtual entity, or “message,” which is transmitted to application server 404 by way of a communication link 422, such as any wired or wireless link and may be over any known network or networks 424, including the Internet. The message, which may also be stored in a gateway database 419, contains information such as the UID of the access control device 410N responsible for the hardware event, the location of the access control device, and the time (local and/or GMT) of occurrence of the hardware event and its recordation. The message itself is uniquely identified by a global unique identifier (GUID), which can be 128 bits long or other design-specific size.

As seen in FIG. 4, one or more cameras 426 are coupled to second gateway 406 by way of a communication link 428, which may be wired or wireless and may be over any network or networks 430, including the Internet. Optionally, the cameras 426 may be controlled by a video controller 439. The second gateway 406 is notified of camera events, which are associated with a UID of the camera 426 responsible for the event, time of occurrence of the event, event location and duration, and so on. This information is relayed to the application server 404 by way of a communication link 429 and/or network 431.

An event video recorder (EVR) 432 receives messages from the application server 404, by way of communication link 434 and/or network 436, and examines the messages, extracting therefrom information relating to hardware events and the particular access control devices 410n involved. EVR 432 also obtains the filters, or rules, associated with the access control device 410n, and determines when the event occurred, based on the GMT and local timestamps. The EVR 432 then determines if action is required, based on the filters examined. If so, it commands (dashed arrows) camera 426 to begin recording and generate camera events as explained above. The command can include the duration of the desired recording and other desired recording details. In lieu of duration, EVR 432 can send a stop recording command after an appropriate period determined by the EVR. When capture is complete, the recording is retrieved from the camera buffer for storage for example in application server database 438, and is assigned a unique identifier which is appended to the original message. In this manner, a message, with its global unique identifier GUID, has associated therewith a hardware event and a recorded camera event.

Generally, the approach as described herein allows the association of specific or multiple security cameras and network video recorder (NVR), digital video recorder (DVR) devices, and IP (internet protocol) based cameras/recorders with the security devices that are defined as part of an access control and security management system. Thus in one embodiment, video from a specific camera 508 (FIG. 5) such as a lobby camera may be associated with one or more security devices (e.g., a door open sensor, and/or an RFID card reader 502 for the door, and/or an electronic lock for the door, and/or a motion detection system or other sensor or detector tied to the video or recorder feed from the camera 508 monitoring the door). This association enables the system to record video clips each time an event (defined by one of the sensors being activated, for example) occurs at the door. Each video clip is then “stamped” or associated with a unique identifier (UID) at the control system 408, and associated with a message having a unique GUID. The UID is relatively unique within the system and is provided by the EVR 432 or optionally may be provided by the access control system 408 for use by the EVR. Optionally the UID is embedded into one or more frames of the digital video clip using a process known in the art as steganography.

In addition, the EVR 432 can have a set of configuration files that tell it when to record its own version of a video clip provided by the recording system 409. For example, EVR 432 may be configured to record video from 5:01 PM up to 7:59 AM the next morning; or all of the time; or as desired by the system administrator. Storage can take place using an EVR database (not shown).

In the first case, if a video event occurs at 11:00 AM the EVR 432 does not record the video event. If a video event occurs at 6:00 PM, the EVR will record the video signal sent from the other video source and store it in its own database.

As described above, unique identifiers (UIDs) are assigned to an event from the control system 408. One is also assigned by the EVR to an event from the video system 409. In one embodiment a unique video clip identifier is maintained within the control system event DB 416. In another embodiment a unique control system event identifier is maintained within the video system ID. In another embodiment a unique control system event ID and the unique video system event ID are linked (e.g., in the message database, or in another database, or the like).

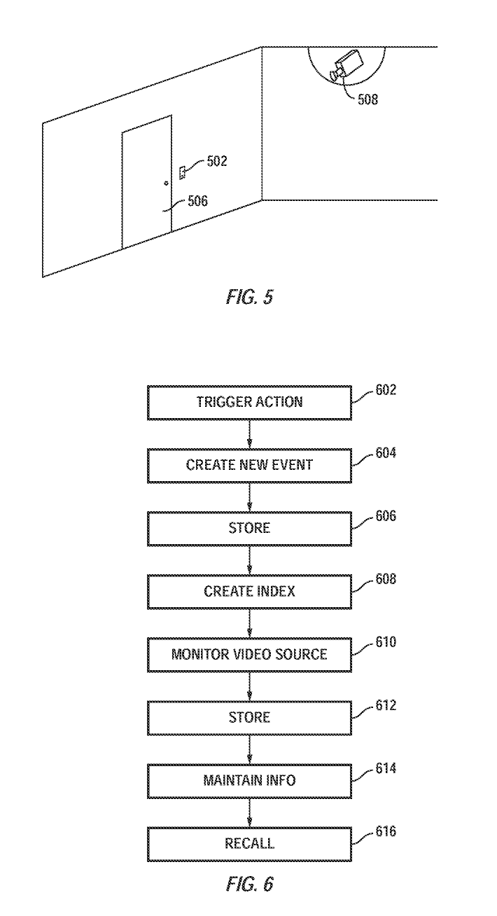

With reference to FIG. 6, a flow information in accordance with one embodiment includes, at 602, triggering, by an external source (person), an action from the control system 408. The control system creates, at 604, a unique hardware event based upon the external source containing type of information. This event contains a unique event ID which is assigned by the control system. At 606, the control system stores that event containing the unique event ID within a database 416. The control system can create, at 608, an index containing that event and the unique event ID. At 610, the EVR 432 monitors a video source (any source of a digital video signal) of recording system 409. Based upon preconfigured filters and configuration instructions, the EVR 432 will store a video clip, at 612. In a stored table that contains video clip headings, information relating to the UID of the stored video clip is maintained, at 614. The heading also includes the GUID of the message associated with the video clip, including time stamp information.

8) When historical information is recalled, at 616, the GUID can be used to call both Control and Video information rather than two separate time.

In accordance with another embodiment, an EVR client 440 having a user interface (not shown) is provided which permits a system administrator (or a guard) to configure, monitor and control the system. This user interface is thus common to multiple devices, such as access control and recording devices, and can be used to access and display the video in a consistent manner regardless of specification or manufacturer so that there is a common look and feel. In accordance with this approach a system administrator may right click on a mouse (not shown) pointing at a video image or an icon and take action with respect to the devices associated with that image, e.g., lock or unlock door; save or unsave the video stream; initiate communication with an individual in the area (using microphones and speakers); initiate or clear an alarm; and the like. Such operation can be through linkage with manifestations of the messages generated above.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. An event-based recording access control and security management system comprising:
an access control system having one or more access control devices;
a recording system having one or more recording devices;
a first gateway configured to generate a message identifying a time of occurrence of a hardware event representative of operation of an access control device; and
an event video recorder (EVR) configured to command information capture by a recording device of the recording system based on the hardware event, and to associate the captured information with the message by including in the message a timestamp of the hardware event and of the information capture.

2. The event-based recording access control and security management system of claim 1, further comprising a controller configured to assign an access control device unique identifier (UID) to each access control device.

3. The event-based recording access control and security management system of claim 2, wherein each recording device has a recording device UID.

4. The event-based recording access control and security management system of claim 3, wherein the message includes the UIDs of the access control device and the recording device.

5. The event-based recording access control and security management system of claim 1, further comprising an EVR client including a user interface through which a message, an access control device, and/or a recording device can be selected.

6. The event-based recording access control and security management system of claim 5, wherein the selected message provides communication access, through the EVR client, to one or more access control devices and/or recording devices associated with the message.

7. The event-based recording access control and security management system of claim 1, wherein each access control device has one or more rules associated therewith.

8. The event-based recording access control and security management system of claim 7, wherein the EVR commands information capture by the recording system based on the one or more rules.

9. A method for associating an access control device with recorded information, comprising:
timestamping a hardware event representative of operation of a first access control device;
generating a message identifying the first access control device and the timestamp; and
commanding a recording device to capture information based on the hardware event, and to associate the captured information with the message by including in the message the timestamp of the hardware event and a timestamp of the information capture.

10. The method of claim 9, further comprising assigning a unique identifier (UID) to the first access control device.

11. The method of claim 10, wherein the recording device has a recording device UID.

12. The method of claim 11, wherein the message includes the UIDs of the first access control device and the recording device.

13. The method of claim 9, further comprising accessing an access control device and/or a recording device using a common user interface.

14. The method of claim 9, further comprising assigning one or more rules to the first access control device.

15. The method of claim 14, wherein commanding a recording device to capture information based on the hardware event is a function of the one or more rules.

16. A device for associating an access control device with recorded information, comprising:
means for timestamping a hardware event representative of operation of a first access control device;
means for generating a message identifying the first access control device and the timestamp; and
means for commanding a recording device to capture information based on the hardware event, and to associate the captured information with the message by including in the message the timestamp of the hardware event and a timestamp of the information capture.

17. The device of claim 16, further comprising means for assigning a unique identifier (UID) to the first access control device.

18. The device of claim 17, wherein the recording device has a UID.

19. The device of claim 18, wherein the message includes the UIDs of the first access control device and the recording device.

20. The device of claim 16, further comprising means for accessing an access control device and/or a recording device using a common user interface.

21. The device of claim 16, further comprising means for assigning one or more rules to the first access control device.

22. The device of claim 21, wherein commanding a recording device to capture information based on the hardware event is a function of the one or more rules.
